(19) United States
(12) Patent Application Publication
(10) Pub. No.: US 2014/0085658 A1
(43) Pub. Date: Mar. 27, 2014

(54) ADDING FUNCTIONALITY TO A PRINTER

(71) Applicants: Michael F. Fallon, Tiverton, RI (US); Myles J. Wilde, Charlestown, MA (US); Matthew Adiletta, Bolton, MA (US)

(72) Inventors: Michael F. Fallon, Tiverton, RI (US); Myles J. Wilde, Charlestown, MA (US); Matthew Adiletta, Bolton, MA (US)

(21) Appl. No.: 13/628,926

(22) Filed: Sep. 27, 2012

(51) Int. Cl. G06F 3/12

(52) U.S. Cl. CPC G06F 3/123; G06F 3/1222
USPC 358/1.14; 358/1.15

(57) ABSTRACT

A system and method of adding a new printer function to a printer is disclosed herein. The system includes the printer. The system also includes a general purpose computing device communicatively coupled to the printer. The system further includes an upgrade module communicatively coupled to the printer, wherein the upgrade module includes a processor and computer-readable instructions to direct the processor to communicate with the printer to add the new print function to the printer

### BACKGROUND

The methods and systems disclosed herein are related to adding functions to printers. Presently, adding a new function or capability to a printer can be expensive for an original equipment manufacturer (OEM). An incremental capability brings an incremental bill of materials (BOM) cost and higher retail prices. The cost of adding multiple functions can be difficult to justify when only around 20% of the functions in printers are used by customers.

### BRIEF DESCRIPTION OF THE FIGURES

FIG. 1 is a block diagram of a system for adding a capability new printer function to a printer.

FIG. 2 is a block diagram of a printer with a computer module configured to add a new printer function.

FIG. 3 is a block diagram of a print system with a location detection module.

FIG. 4 is a block diagram of a print system with a module for interfacing with a mobile device.

FIG. 5 is a block diagram of a print system with a module for identifying a user.

FIG. 6 is a process flow diagram of a method to add a location detection function to a printer.

FIG. 7 is a process flow diagram of a method to add a wireless communication function to a printer.

FIG. 8 is a process flow diagram of a method to add a user identification function to a printer.

### DETAILED DESCRIPTION

According to embodiments of the subject matter disclosed in this application, an upgrade module, also referred to herein as a Computer on an Upgrade Stick (COUS). offers a method of adding a new printer function to a printer without increasing the bill of materials cost to the printer itself. The COUS may be an internal module installed into a printer by a manufacturer, or an external plug-in module that customers can purchase separately. The COUS may be compatible with any existing or future printing device, from a simple home desktop printer to an advanced multi-function printer. The COUS may contain a central processing unit (CPU), memory, software, and any peripherals needed to perform its function. The COUS enables the printer manufacturer to provide lower cost printers, while enabling users to purchase specific upgrade capabilities that they are interested in. No changes to the printer's embedded software or hardware are necessary, as the COUS can be configured to couple with the printer through a communication port on the printer. For example, the COUS can use an existing, industry-standard USB port on the printer, and can communicate over this channel using industry standard protocols such as Printer Control Language (PCL) or Postscript.

Any number of new printer functions may be added to the printer through the COUS. In one embodiment, the COUS can determine the location of itself and the printer, and transmit the location data to one or more computers for location services. In another embodiment, the COUS can act as an interface between the printer and a mobile device, thus, enabling the printer to communicate with the mobile device. The COUS may enable a secure communication channel and protocol stack, which are capabilities that may not be native to the printer. In another embodiment, the COUS can recognize a user identification tag from a remote point, and grant the associated user permission to print. Identification of the user can also enable the printer to print with user specific features enabled. It is to be understood that the embodiments illustrated in the following figures do not represent all of the possible new printer functions that the COUS is able to add.

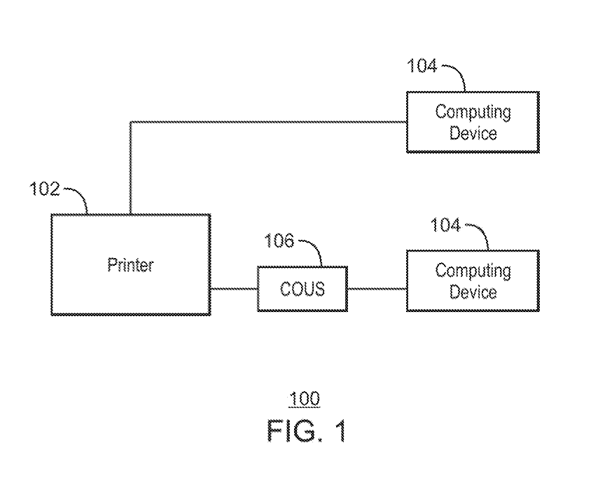

FIG. 1 is a block diagram of a system for adding a new printer function to a printer. In the system 100, a printer 102 may be connected to a computing device. The computing device 104 may be a desktop or laptop computer, or any device that is normally configured to send information to the printer 102 to be printed. The printer 102 may be a multi-function printer in an, office environment, or a simple desk printer in a person's home.

The printer 102 may be connected to a COUS 106, which can provide the printer 102 with one or more additional functions. The variety of functions that may be added may include, but are not limited to, location detection, mobile device interface, user identification, security, wireless communication, memory storage, and additional communication protocols. The COUS 106 may also be connected to a computing device 104, which can allow a user to access and control the functions featured on the COUS 106. The COUS 106 may also be connected to a network or server.

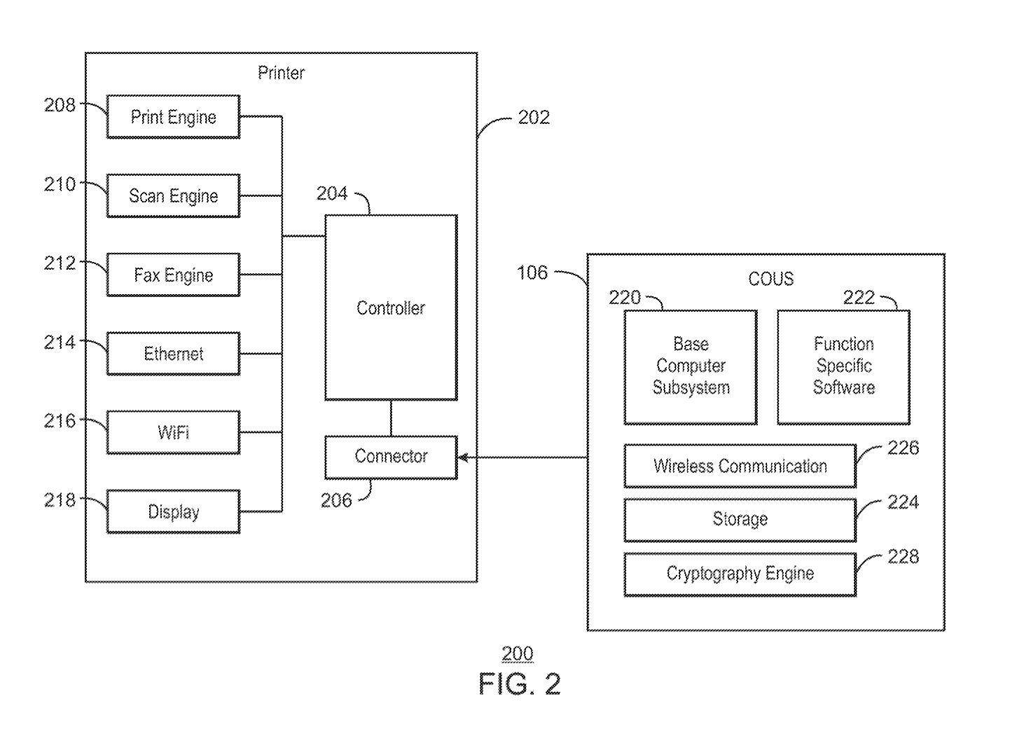

FIG. 2 is a block diagram of a printer with a computer module configured to add a new printer function. In this embodiment, the printer 200 contains a controller 204 configured to control the operations of the printer. The printer 202 may also contain a connector 206 that is capable of interacting with a peripheral device. The connector 206 may be a Universal Serial Bus (USB) port or any other suitable interface. The printer 202 may also include a print engine 208, a scan engine 210, a fax engine 212, an Ethernet module 214, a WiFi module 216, and a display 218.

The connector 206 may interact with the COUS 106. The COUS 106 may include a base computer subsystem 220 that can serve as the COUS's central processor and function specific software 222 that is necessary to perform the COUS's additive printer functions. The COUS 106 may also contain additional modules or periphery features that can aid the COUS's new printer functions. In one embodiment, the COUS may contain a storage unit 224, a wireless communicator 226, and a cryptography engine 228. The wireless communicator 226 allows the COUS 106 to exchange information with a mobile device without a direct connection such as a wire or cable. The mobile device may be a smartphone, a tablet computer, or any device that is not configured to directly connect with the printer 202. The cryptography engine 228 allows the COUS 106 to encode outgoing information being transmitted from the COUS 106 to other devices, or decode incoming information being received by the COUS 106 from other devices.

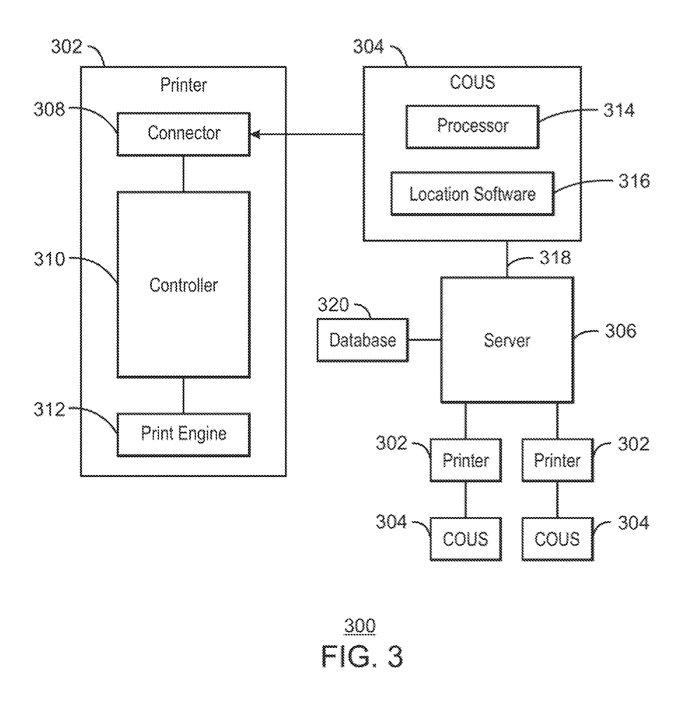

FIG. 3 is a block diagram of a print system with a location detection module. Location detection can be useful in providing a user with the location of the printer. For example, in an office environment, a multi-function printer may be connected remotely to several office computers. A user on a computer can print from the office, receive the location information of the printer from a server or database, and retrieve the printed information from that location. In the embodiment of FIG. 3, the system 300 features a printer 302 with a COUS 304 connected. The COUS 304 may be configured to calculate the location of the printer 302 while the COUS 304 is connected. Any suitable location detection device may be used to determine the printer's location. For example, the location can be calculated using a global positioning system (GPS), triangulation, or it may be entered manually into the COUS 304 by a user. The COUS 304 can transmit the location to a server 306.

The printer 302 may contain a connector 308, a controller 310, and a print engine 312. The COUS 304, which is configured to interact with the printer 302 through the connector 308, may contain a processor 314 and location software 316. The processor 314 controls the operations of the COUS 304. The location software 316 contains coding that can determine the printer's position, either globally or within a local environment such as a building layout. The COUS 304 can transmit the location information to the server 306. The location information may be transmitted to the server 306 through a network 318, which may be wired or wireless. The location information is received by the server 306, which may also be connected to multiple printers 302, each with a COUS 304 configured for location detection attached. The server 306 may store the location information of each printer 302 in a database, so that the location information can be readily accessed by computers.

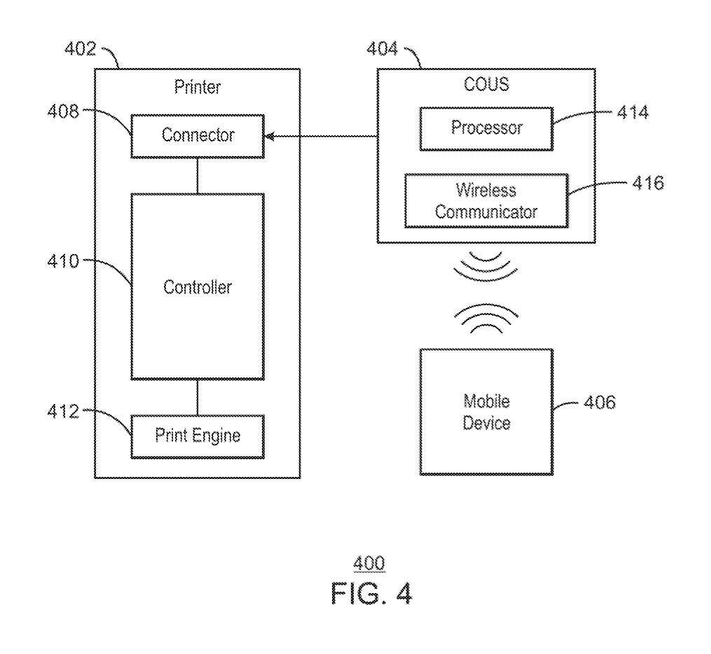

FIG. 4 is a block diagram of a print system with a module for interfacing with a mobile device. In one embodiment, the system 400 features a printer 402 with a COUS 404 connected. The COUS 404 is configured to communicate with a mobile device 406 using wireless communication. Examples of wireless communication may include WiFi, Bluetooth, and nearfield communication, among others.

The printer 402 may contain a connector 408, a controller 410, and a print engine 412. The COUS 404, which is configured to interact with the printer 402 through the connector 408, may contain a processor 414 and a first wireless communicator 416. The processor 414 controls the operations of the COUS 404. The first wireless communicator 416 may be configured to interact with a second wireless communicator in the mobile device 406. The mobile device 406 may be a smart phone, a tablet computer, or any other electronic computing device. The first wireless communicator 416 can detect when the mobile device is within a certain range. Upon detection, the mobile device 406 may establish a wireless connection with the COUS 404. Once connected, the mobile device 406 can exchange information with the COUS 404 through their respective wireless communicators. In one embodiment, the mobile device 404 can send documents to the COUS 404 to be printed by the printer 402.

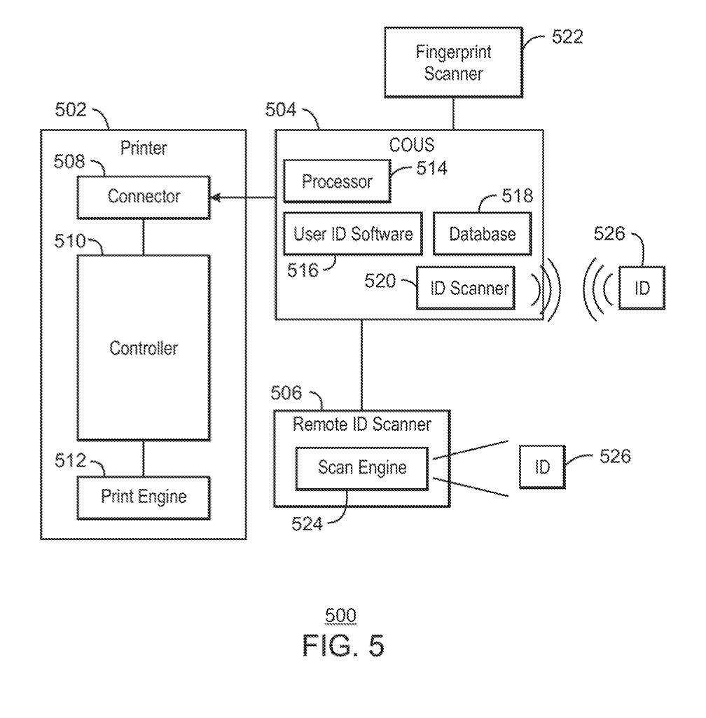

FIG. 5 is a block diagram of a print system with a module for identifying a user. In one embodiment, the system 500 features a printer 502 with a COUS 504 connected. The COUS 504 is configured to recognize a user identification scanned by the COUS 504 itself, or by a remote ID scanner 506. This system 500 can be utilized to prevent unauthorized users from accessing the printer 502, or to allow authorized users to print from remote locations. In one example, a user can send a document to the printer 502, and be required to provide a form of identification (such as a barcode, radio frequency tag, or fingerprint) before the printer 502 processes the print job. In another example, the printer 502 can print with certain settings unique to the identified user.

The printer 502 may contain a connector 508, a controller 510, and a print engine 512. The COUS 504, which is configured to interact with the printer 502 through the connector 508, may contain a processor 514, user ID software 516, a database 518, and an ID reader 520. In some embodiments, the COUS 504 can also be connected to a fingerprint reader 522. The processor 514 controls the operations of the COUS 504.

The COUS 504 is configured to scan and recognize an ID tag, either through its own ID scanner 520 or through the remote ID scanner 506. The identification information is received by the COUS transmitter 520. The user ID software 516 processes the identification information by comparing the identification information with a list of authorized users in the database 518. If the identification information does indeed correspond with the list of identifications, then the ID tag 526 is approved. The COUS can also scan and recognize a fingerprint using the fingerprint reader 522, and compare the fingerprint with a list of authorized user fingerprints in the database 518

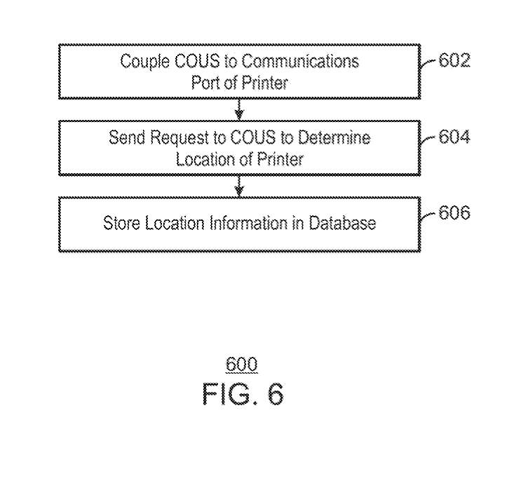

FIG. 6 is a process flow diagram of a method to add a location detection function to a printer. The method 600 may be performed by a user operating a print system similar to that described in FIG. 3. At block 602, the user can couple the COUS to a communications port on the printer. The COUS may include a processor and an interface through which the COUS can communicate with the printer. The COUS may also contain computer-readable instructions that, when executed by the processor, direct the processor to communicate with the printer to add the location detection function.

At block 604, the user can send a request to the COUS to determine the location of the printer. The request can be sent from a computer or device that may be directly connected to the COUS, or connected communicatively through a server. The COUS can determine the printer's position, either globally or within a local environment such as a building layout. The COUS can transmit the printer's location to the computer or the server.

At block 606, the user can store information pertaining to the location of the printer in a database. The database may be associated with the computer, or it may be associated with the server. Storing the location information in the database can enable users to look up the printer's location.

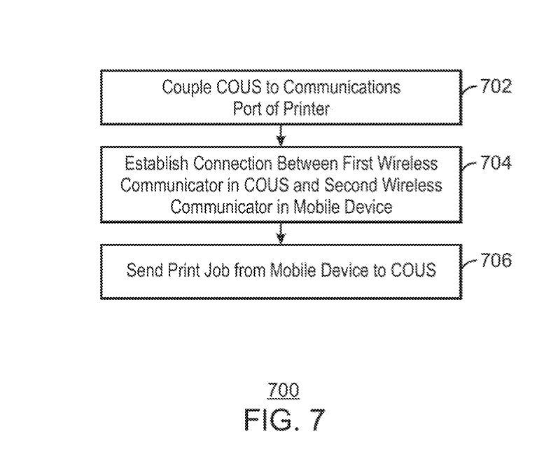

FIG. 7 is a process flow diagram of a method to add a wireless communication function to a printer. The method 700 may be performed by a user operating a print system similar to that described in FIG. 4. At block 702, the user can couple the COUS to a communications port on the printer. The COUS may include a processor and an interface through which the COUS can communicate to the printer with. The COUS may also contain computer-readable instructions that, when executed by the processor, direct the processor to communicate with the printer to add the wireless communication function.

At block 704, the user can establish a connection between a first wireless communicator in the COUS and a second wireless communicator in a mobile device. The connection can be established by moving the mobile device within range of the COUS, where the first wireless communicator automatically detects the presence of the second wireless communicator. The connection can also be established manually, in which the user sends a request from the mobile device to connect to the COUS through the first and second wireless communicators.

At block 706, the user can send a print job from the mobile device to the COUS. The print job may be any document or image stored on the mobile device. The print job may be sent through any means of wireless communication. Examples of wireless communication may include WiFi, Bluetooth, and nearfield communication. The COUS forwards the print job to the printer through the communications port on the printer.

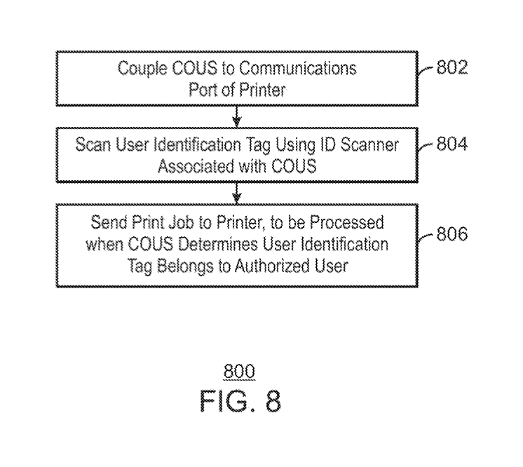

FIG. 8 is a process flow diagram of a method to add a user identification function to a printer. The method 800 may be performed by a user operating a print system similar to that described in FIG. 5. At block 802, the user can couple the COUS to a communications port on the printer. The COUS may include a processor and an interface through which the COUS can communicate to the printer with. The COUS may also contain computer-readable instructions that, when executed by the processor, direct the processor to communicate with the printer to add the user identification function.

At block 804, the user can scan a user identification tag using an ID scanner associated with the COUS. The user identification tag may be a barcode, a computer-readable serial number, a radio-frequency identification (RFID) tag, a fingerprint, or any other user-unique form of user identification. The ID scanner may be a component on the COUS itself or an external device connected to the COUS. The act of scanning the user identification sends scanned identification information pertaining to the user identification tag to the COUS, where the scanned identification information is compared to a list of authorized users contained in a database. The list of authorized users can contain identification information associated with each authorized user. The COUS determines whether or not the scanned identification information is associated with one of the authorized users in the list of authorized users.

At block 806, the user can send a print job to the printer. The print job can be processed if the COUS determines that the scanned identification information is associated with one of the authorized users contained in the list of authorized users. The COUS forwards the print job to the printer through the communications port on the printer.

Although some embodiments have been described in reference to particular implementations, other implementations are possible according to some embodiments. Additionally, the arrangement and order of circuit elements or other features illustrated the drawings or described herein need not be arranged in the particular way illustrated and described. Many other arrangements are possible according to some embodiments.

In each system shown in a figure, the elements in some cases may each have a same reference number or a different reference number to suggest that the elements represented could be different or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

1. A system comprising:
a printer;
a general purpose computing device communicatively coupled to the printer; and
an upgrade module communicatively coupled to the printer, the upgrade module comprising a processor and computer-readable instructions that, when executed by the processor, direct the processor to communicate with the printer to add a new printer function to the printer

2. The system of claim 1, wherein the general purpose computing device is coupled to the printer through the printer's industry standard USB interface.

3. The system of claim 1, wherein the general purpose computing device is coupled to the printer through the upgrade module.

4. The system of claim 1, wherein the upgrade module is enclosed within a housing of the printer by the printer manufacturer.

5. The system of claim 1, wherein the upgrade module is coupled to a standard communication port of the printer.

6. The system of claim 1, wherein the upgrade module comprises a wireless interface and the new printer function is to receive a print job from a mobile device through the wireless interface and send the print job to the printer.

7. The system of claim 1, wherein the new printer function is to store a location of the printer and communicate the location to a second electronic device.

8. The system of claim 1, wherein the upgrade module is to receive user identification and compare the user identification to a list of authorized users to determine whether to process a print job.

9. An upgrade module, comprising:
a processor;
an interface to communicatively couple the upgrade module to a printer; and
computer-readable instructions that, when executed by the processor, direct the processor to communicate with the printer to add a new printer function to the printer.

10. The upgrade module of claim 9, wherein the new function is to determine a location of the printer and communicate the location to a second electronic device.

11. The upgrade module of claim 10, wherein the upgrade module comprises location detection technology to determine the location of the printer.

12. The upgrade module of claim 9, further comprising a first wireless communicator to detect and interact with a second wireless communicator from a mobile device.

13. The upgrade module of claim 9, wherein the computer-readable instructions are for receiving a user identification and comparing the user identification to a list of authorized users to determine whether to process a print job.

14. The upgrade module of claim 13, wherein the upgrade module comprises an ID scanner to detect and recognize a user identification tag.

15. The upgrade module of claim 13, wherein the upgrade module comprises a fingerprint scanner to scan and recognize a user's fingerprint.

16. The upgrade module of claim 13, wherein the upgrade module comprises a database to store the list of authorized users along with identification information pertaining to the authorized users.

17. The upgrade module of claim 9, further comprising a cryptography engine to encode outgoing information being transmitted from the upgrade module or decode incoming information received by the upgrade module.

18. A method, comprising:
coupling a self-contained upgrade module to a communications port of a printer, wherein the upgrade module comprises:
a processor;
an interface to communicatively couple the upgrade module to the printer; and
computer-readable instructions that, when executed by the processor, direct the processor to communicate with the printer to add a new printer function to the printer.

19. The method of claim 18, wherein the upgrade module comprises a location detection device, the method comprising:
sending a request to the upgrade module to determine the location of the printer; and
storing information pertaining to the location of the printer in a database.

20. The method of claim 18, comprising:
establishing a connection between a first wireless communicator in the upgrade module and a second wireless communicator in a mobile device; and
sending a print job from a mobile device to the upgrade module using the first and second wireless communicators, wherein the upgrade module sends the print job to the printer through the communications port of the printer.

21. The method of claim 18, comprising:
scanning a user identification tag using an ID scanner associated with the upgrade module, wherein scanning the user identification tag sends identification information pertaining to the user identification tag to the upgrade module to be compared to a list of authorized users; and
sending a print job to the printer, to be processed when the upgrade module determines that the identification information belongs to an authorized user.
